(19) United States
(12) Patent Application Publication
(10) Pub. No.: US 2012/0023437 A1
(43) Pub. Date: Jan. 26, 2012

(54) INFORMATION PROCESSING APPARATUS AND DISPLAY REGION ARRANGEMENT METHOD

(75) Inventor: Noritaka Moriwaki, Fussa-shi (JP)

(73) Assignee: KABUSHIKI KAISHA TOSHIBA, Tokyo (JP)

(21) Appl. No.: 13/186,164

(22) Filed: Jul. 19, 2011

(30) Foreign Application Priority Data
Jul. 20, 2010 (JP) 2010-163347

(51) Int. Cl. G06F 3/048

(52) U.S. Cl. 715/781

(57) ABSTRACT

According to one embodiment, an information processing apparatus includes a CPU, a display, a recording module and an arrangement module. The recording module is configured to record a plurality of position information items each indicating a position on a screen of the display. The position on the screen is a position where a display region of an application program executed by the CPU is arranged. The plurality of position information items is recorded in accordance with the number of application programs simultaneously executed. The simultaneously executed application programs are identical. The arrangement module is configured to arrange display regions on the screen based on the plurality of position information items when the respective application programs are activated.

### CROSS-REFERENCE TO RELATED APPLICATIONS

This application is based upon and claims the benefit of priority from Japanese Patent Application No. 2010-163347, filed Jul. 20, 2010; the entire contents of which are incorporated herein by reference.

### FIELD

Embodiments described herein relate generally to an information processing apparatus such as a personal computer and a display region arrangement method in the information processing apparatus.

### BACKGROUND

Recently, various types of personal computers such as notebook and desktop computers are widely used. The user uses this type of personal computer to make use of various types of application programs such as document creation software, spreadsheet software, browser, mailer and the like.

At the application program start time, a display region for the application program that is referred to as a window is secured on the display screen of a display device by an operating system (OS) that handles resource management of the personal computer. Since the OS includes a multi-window function of displaying a plurality of windows, the user can simultaneously utilize a plurality of application programs. As a configuration of simultaneously utilizing a plurality of application programs, not only a configuration of utilizing a plurality of different types of application programs to display, for example, a window for browser and a window for document creation software side by side but also a configuration of utilizing a plurality of application programs of the same type to display, for example, two windows for spreadsheet software side by side can be provided.

In order to enhance the operability of the user, various types of mechanisms how to display windows of various types of application programs are proposed so far.

Further, recently, a utilization method for displaying the screen is often used by using two display devices by further connecting an external display device to a notebook personal computer including a liquid crystal display (LCD) mounted thereon, for example. The above utilization method is referred to as multi-monitoring. In this case, two windows can be displayed on the different display devices.

The OS records a position of the display screen in which the window of each application program has been arranged. Therefore, if an application program is started again after the application program is ended, the window of the application program is arranged in a position where the window was arranged at the end time in the preceding cycle.

However, the OS records only the position where the window of each application program was finally arranged. Therefore, when a plurality of same application programs are started, all of the windows are arranged around the recorded position.

For example, it is assumed that the two same application programs are started in multi-monitoring and the windows thereof are displayed on different display devices (display device A, display device B). Further, it is assumed that two application programs including the application program whose window is arranged on display device A and the application program whose window is arranged on display device B are ended in this order. Then, if the two application programs are started in the next cycle, both of the windows are displayed on display device B.

Likewise, it is assumed that two application programs including the application program whose window is arranged on display device B and the application program whose window is arranged on display device A are ended in this order. Then, if the two application programs are started in the next cycle, both of the windows are displayed on display device A.

That is, when the user tries to utilize the two same application programs in the same state as that of the preceding cycle, it becomes necessary to perform an operation of moving the window of one of the application programs that is started later, for example, back to the original position (where the window of one of the application programs that was first ended was arranged in the preceding cycle) after the two application programs were started.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view showing the appearance of an information processing apparatus of the embodiment.

FIG. 2 is an exemplary diagram showing the system configuration of the information processing apparatus of the embodiment.

FIG. 3 is an exemplary view showing a state in which the two same application programs (application X) are started on the information processing apparatus of the embodiment and the windows thereof are separately arranged on two LCDs.

FIG. 4 is an exemplary view showing a first arrangement example of the window when application X (first) is restarted on the information processing apparatus of the embodiment.

FIG. 5 is an exemplary view showing a first arrangement example of the window when application X (second) is restarted on the conventional information processing apparatus.

FIG. 6 is an exemplary view showing a first arrangement example of the window when application X (second) is restarted on the information processing apparatus of the embodiment.

FIG. 7 is an exemplary view showing a second arrangement example of the window when application X (first) is restarted on the information processing apparatus of the embodiment.

FIG. 8 is an exemplary view showing a second arrangement example of the window when application X (second) is restarted on the conventional information processing apparatus.

FIG. 9 is an exemplary view showing a second arrangement example of the window when application X (second) is restarted on the information processing apparatus of the embodiment.

FIG. 10 is an exemplary flowchart showing an operation procedure at the end time of an application program of an application control module in an operating system running on the information processing apparatus of the embodiment.

FIG. 11 is an exemplary flowchart showing an operation procedure at the start time of an application program of an application control module in an operating system running on the information processing apparatus of the embodiment.

FIG. 12 is an exemplary view showing a first application example of arrangement control of the window of an application program executed on the information processing apparatus of the embodiment.

FIG. 13 is an exemplary view showing a second application example of arrangement control of the window of an application program executed on the information processing apparatus of the embodiment.

### DETAILED DESCRIPTION

Various embodiments will be described hereinafter with reference to the accompanying drawings.

In general, according to one embodiment, an information processing apparatus includes a CPU, a display, a recording module and an arrangement module. The recording module is configured to record a plurality of position information items each indicating a position on a screen of the display. The position on the screen is a position where a display region of an application program executed by the CPU is arranged. The plurality of position information items is recorded in accordance with the number of application programs simultaneously executed. The simultaneously executed application programs are identical. The arrangement module is configured to arrange display regions on the screen based on the plurality of position information items when the respective application programs are activated.

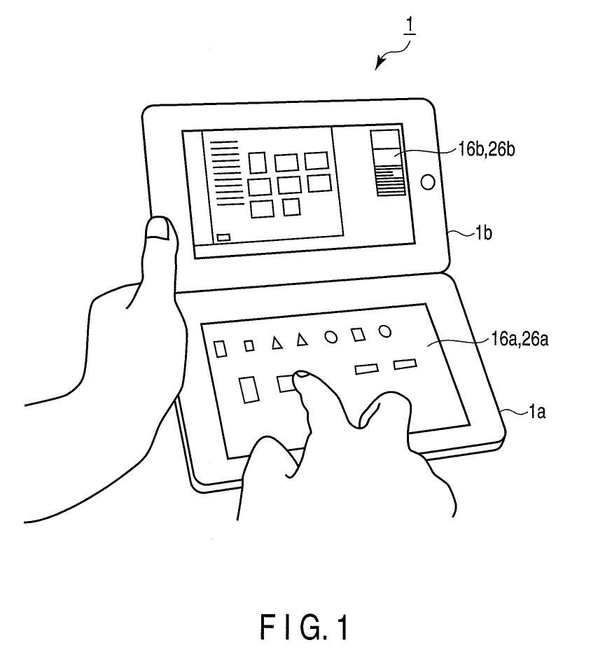

FIG. 1 is an exemplary view showing the appearance of an information processing apparatus of the embodiment. For example, the present information processing apparatus is realized as a notebook personal computer 1 that can be battery-driven and is easy to carry.

As shown in FIG. 1, the computer 1 includes a main body portion 1a and lid portion 1b. The lid portion 1b is mounted on the main body portion 1a to freely rotate between an open position in which the upper surface of the main body portion 1a is exposed and a closed position in which the lid portion covers the upper surface of the main body portion 1a.

In the main body portion 1a, a liquid crystal display (LCD) 16a and touch panel 26a are stacked and incorporated. Likewise, in the lid portion 1b, an LCD 16b and touch panel 26b are stacked and incorporated. The computer 1 includes a multi-monitoring function of using both of the LCD 16a on the main body portion 1a side and the LCD 16b on the lid portion 1b side for screen display. Further, the computer 1 includes a software keyboard function of displaying a keyboard on the LCD 16a on the main body portion 1a side (while only the LCD 16b on the lid portion 1b side is used for screen display) and receiving key input by detecting a touch operation portion on the keyboard by use of the touch panel 26a.

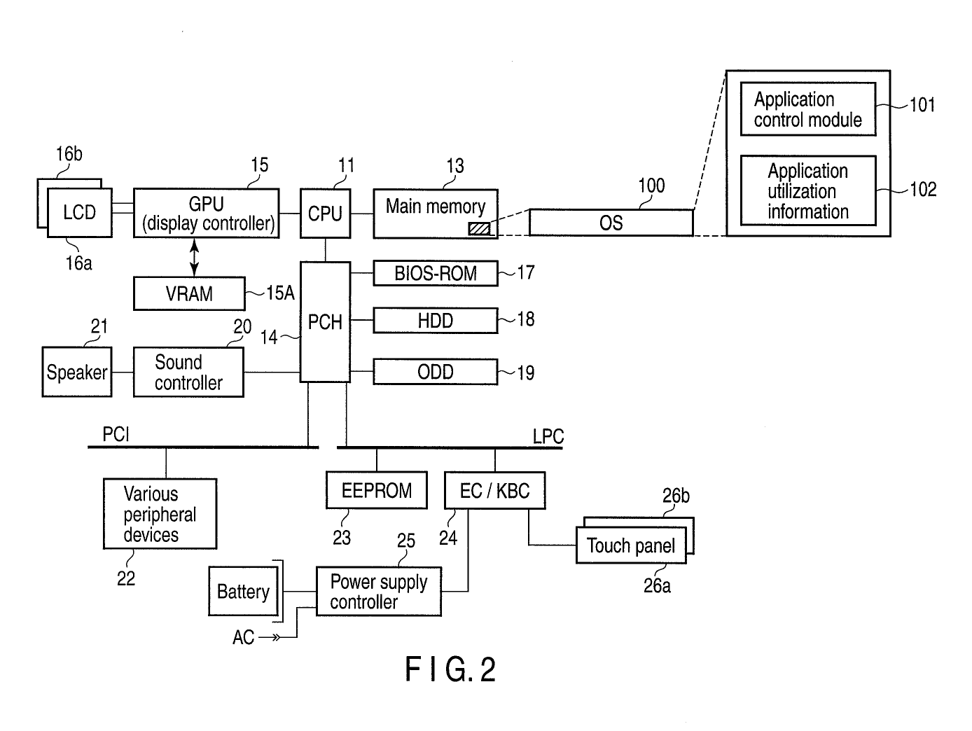

FIG. 2 is an exemplary diagram showing the system configuration of the information processing apparatus of the embodiment.

As shown in FIG. 2, the computer 1 includes a central processing unit (CPU) 11, main memory 13, platform controller hub (PCH) 14 and graphics processing unit (GPU: display controller) 15. Further, the computer 1 includes a video memory (video random access memory [VRAM]) 15A, LCDs 16a, 16b, Basic Input/Output System (BIOS) read-only memory (ROM) 17, hard disc drive (HDD) 18, optical disc drive (ODD) 19 and sound controller 20. Additionally, the computer 1 includes a speaker 21, various peripheral devices 22, electrically erasable programmable ROM (EEPROM) 23, embedded controller/keyboard controller (EC/KBC) 24, power supply controller 25 and touch panels 26a, 26b.

The CPU 11 is a processor for controlling the operation of the computer 1. The CPU 11 executes various programs loaded from the HDD 18 and ODD 19 to the main memory 13. Further, the CPU 11 includes a function of a memory controller that controls access to the main memory 13 and a function of performing communications with the GPU 15. Among the various programs executed by the CPU 11, an OS 100 that conducts resource management, various application programs run under the OS 100 and the like are present. Further, the CPU 11 executes a BIOS stored in the BIOS-ROM 17. The BIOS is a program for hardware control.

The GPU 15 is a display controller that controls the LCDs 16a, 16b incorporated in the computer 1. The GPU 15 includes the VRAM 15A. Further, an accelerator that draws an image to be displayed according to each program instead of the CPU 11 is mounted on the GPU 15.

The PCH 14 contains an Integrated Drive Electronics (IDE) controller that controls the HDD 18 and ODD 19. The PCH 14 also controls the various peripheral devices 22 connected to a Peripheral Component Interconnect (PCI) bus. Further, the PCH 14 includes a function of communicating with the sound controller 20. The sound controller 20 is a sound source device and outputs audio data to be reproduced according to the various programs to the speaker 21 incorporated in the computer 1.

The EEPROM 23 is a memory device that stores individual information of the computer 1, for example. The EC/KBC 24 is a one-chip micro processing unit (MPU) in which an embedded controller that performs power management in cooperation with the power supply controller 25 and a keyboard controller that controls data input by the touch operation on the touch panels 26a, 26b are integrated.

The OS 100 that runs on the computer 1 with the above configuration to conduct the resource management of the computer 1 includes an application control module 101 that performs various control operations relating to the application program. As one of the processes performed by the application control module 101, a process for arranging a display region (window) for an application program in an adequate position on the display screen at the start time of the application program is provided. Next, the operation principle of the application control module 101 related to the above process is explained in detail.

The user moves the window on the display screen or changes the size of the window to make operations easy after an application program is started. In order to reconstruct the arrangement of the window after adjustment by the user, the application control module 101 records information indicating the position where the window is arranged on the display screen as application utilization information 102 at the end time of the application program. More specifically, for example, the coordinates of the upper left end portion of the window and the size (height and width) thereof are recorded. Then, when the application program is started in the next cycle, the application control module 101 arranges the window according to the application utilization information 102. As a result, the user can restart the operation in a state that is adjusted by himself in the preceding cycle without performing an operation of moving the window on the display screen or changing the size of the window again.

Further, the application control module 101 of the embodiment can record a plurality of arrangements of the windows of the respective application programs as the application utilization information 102. That is, if the same application programs of, for example, two are started and the respective windows thereof are arranged on the display screen, the arrangements of the two windows can be recorded as the application utilization information 102. Then, if the two application programs are started in the next cycle as in the former case, the arrangement of the two windows can be realized again based on the application utilization information 102.

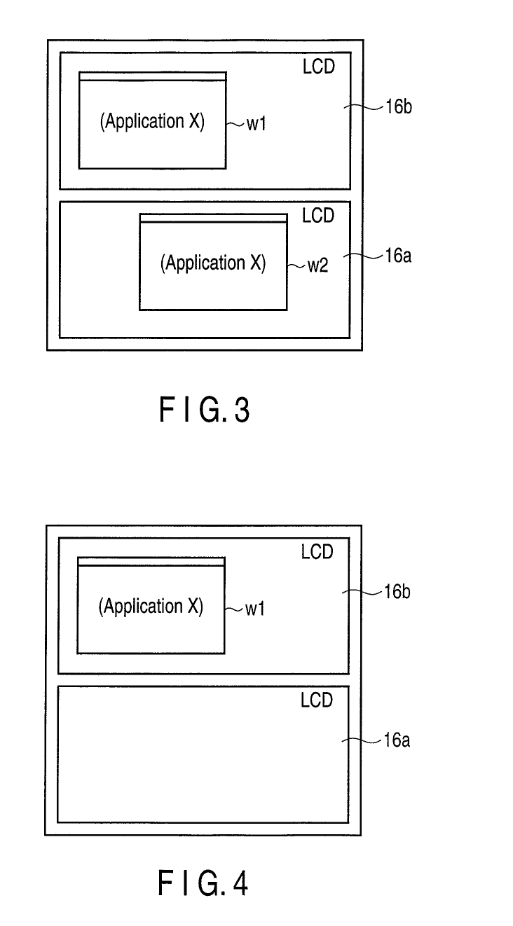

It is now assumed that two application programs (referred to as applications X) are started and window w1 and window w2 are respectively arranged on the LCD 16b (on the lid portion 1b side) and the LCD 16a (on the main portion 1a side) as shown in FIG. 3.

In this case, it is assumed that the user who has ended the operation using application X first closes window w2 on the LCD 16a side (terminates application X on the window w2 side) and then he closes window w1 on the LCD 16b side. At this time, the application control module 101 records two arrangements of window w2 and window w1 so that the time-sequential relationship of two arrangements of window w2 and window w1 is identifiable.

After this, if application X (first) is started, the application control module 101 selects the arrangement of the window recorded at the latest time (that is, window w1, which is closed later) among the arrangements of the two windows recorded as the application utilization information 102 for application X. Then, the application control module 101 arranges the window of newly started application X on the display screen according to the selected arrangement. FIG. 4 is an exemplary view showing a state in which window w1 is arranged on the LCD 16b when first application X is started.

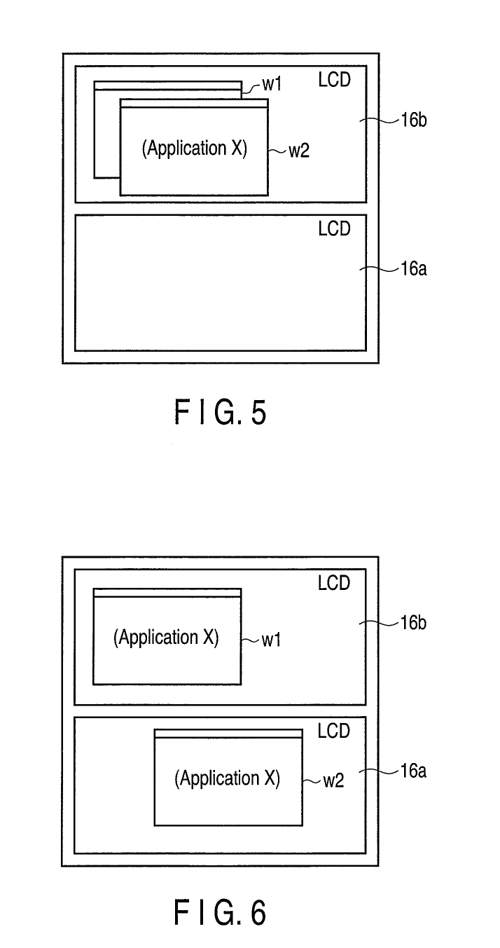

Subsequently, a case where application X (second) is started is considered. In the conventional case, only the last one of the arrangements of the windows of the respective application programs is recorded. Therefore, in this case, window w2 of application X, which is started second, is arranged near window w1 of application X, which is started first, as shown in FIG. 5. Therefore, the user is required to perform the operation of moving window w2 from the LCD 16b side to the LCD 16a side to reconstruct the operating state of the preceding cycle.

On the other hand, the application control module 101 of this embodiment records a plurality of arrangements of windows of the respective application programs as described before. Therefore, at the start time of application X (second), the application control module 101 selects the arrangement of a window that is second newly recorded (that is, window w2, which is closed first) among the arrangements of the two windows recorded as the application utilization information 102 for application X. Then, the application control module 101 arranges the window of newly started application X on the display screen according to the selected arrangement. FIG. 6 is an exemplary view showing a state in which window w2 is arranged on the LCD 16a when second application X is started.

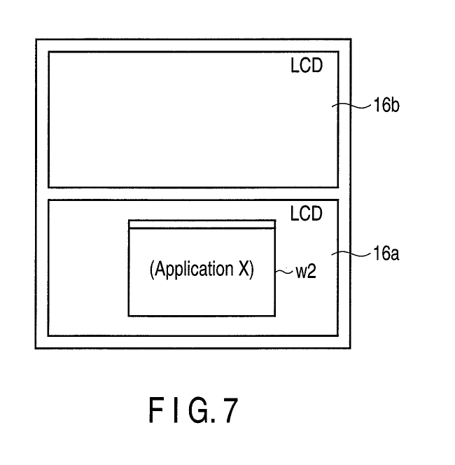

It is now assumed that the windows are sequentially closed in an order of window w1 on the LCD 16b side and window w2 on the LCD 16a side. After this, if application X (first) is started, the application control module 101 selects the arrangement of the window recorded at the latest time (that is, window w2, which is closed later) among the arrangements of the two windows recorded as the application utilization information 102 for application X. Then, the application control module 101 arranges the window of newly started application X on the display screen according to the selected arrangement. FIG. 7 is an exemplary view showing a state in which window w2 is arranged on the LCD 16a when first application X is started.

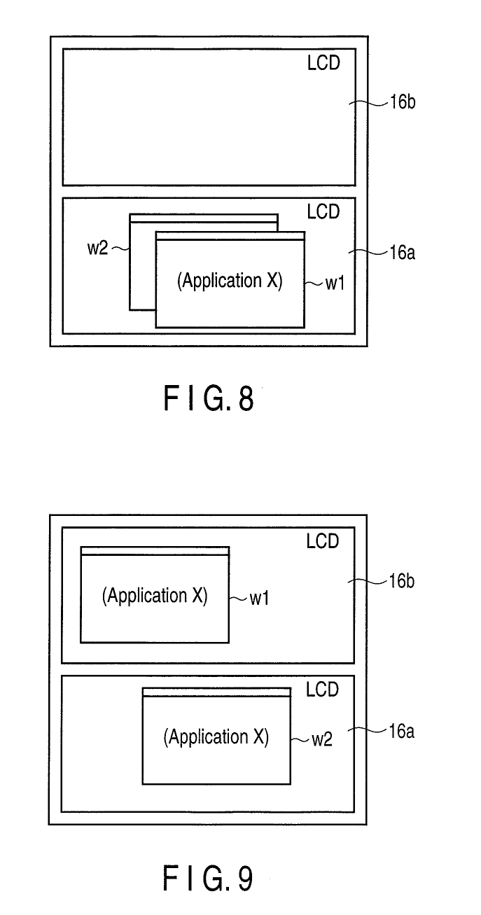

Subsequently, if application X (second) is started, window w1 of second started application X is arranged near window w2 of first started application X as shown in FIG. 8 like the former case in the conventional case. Therefore, the user must move window w1 from the LCD 16a side to the LCD 16b side to reconstruct the operating state of the preceding cycle.

On the other hand, when application X (second) is started, the application control module 101 of this embodiment selects the arrangement of a window that is second newly recorded (that is, window w1, which is closed first) among the arrangements of the two windows recorded as the application utilization information 102 for application X. Then, the application control module 101 arranges the window of newly started application X on the display screen according to the selected arrangement. FIG. 9 is an exemplary view showing a state in which window w1 is arranged on the LCD 16b when second application X is started.

Thus, the computer 1 of this embodiment properly arranges the display region at the start time of a plurality of same application programs by recording a plurality of arrangements of the windows of the respective application programs.

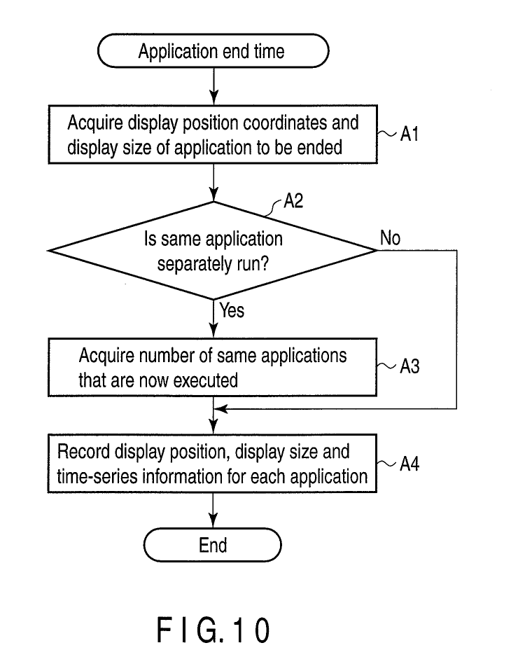

FIG. 10 is an exemplary flowchart showing an operation procedure at the end time of an application program of the application control module 101 in the OS 100 running on the computer 1.

When any one of the application programs is terminated, the application control module 101 first acquires the display position and display size of a window of the application program to be terminated (block A1). Further, the application control module 101 checks whether an application program that is the same as the application program to be terminated is separately run or not (block A2). If the same application program that is separately run is present (YES in block A2), the application control module 101 acquires the number of other application programs that are being run (block A3). Then, the application control module 101 records the display position, display size and time-series information of the window of the to-be-terminated application program for each application program (block A4). The time-series information is information that can be used to identify the order of the window that is newly (lately) closed among the same application programs that are started at the same time. As the time-series information, for example, a value of “the number of other application programs that are now being run +1” is recorded.

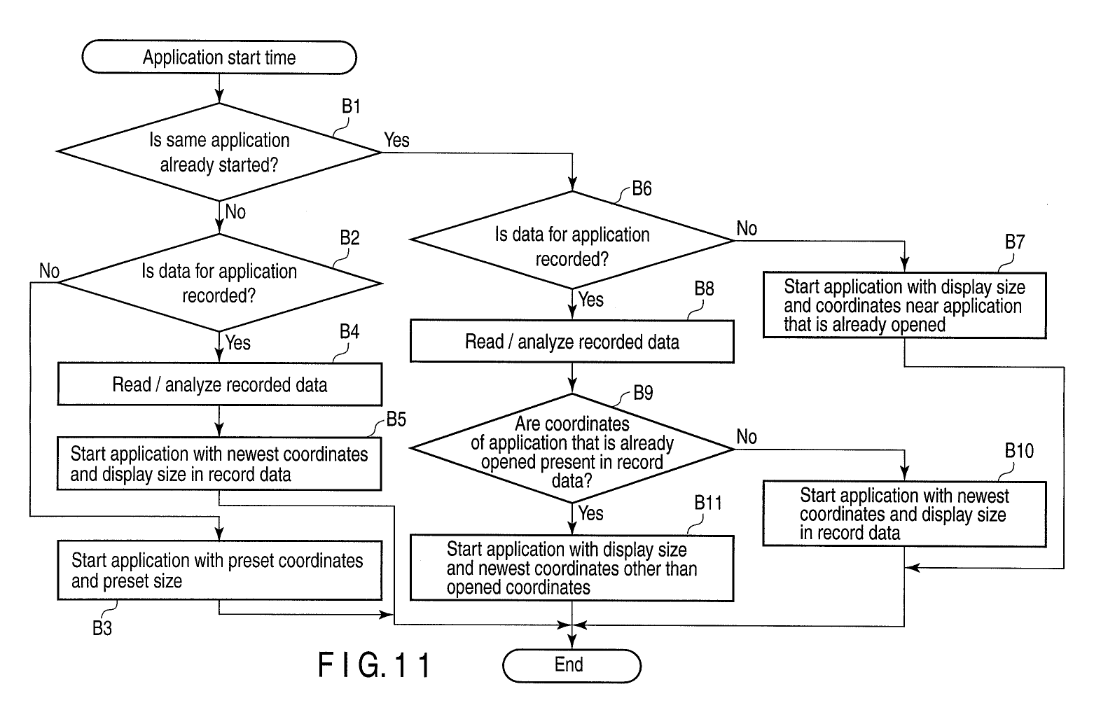

FIG. 11 is an exemplary flowchart showing an operation procedure at the start time of an application program of the application control module 101 in the OS 100 running on the computer 1.

When any one of the application programs is started, the application control module 101 first checks whether an application program that is the same as the application program to be started is already started or not (block B1). If the same application program that is already started is not present (NO in block B1), the application control module 101 checks whether data (application utilization information 102) recorded for the above application program is present or not (block B2). If the recorded data for the application program is not present (NO in block B2), the application control module 101 arranges the window of the application program with preset coordinates and a preset size determined based on a preset rule (block B3).

If the recorded data for the application program is present (YES in block B2), the application control module 101 reads and analyzes the record data (block B4). Then, the application control module 101 arranges the window for the application program with the newest coordinates and size among the record data (block B5).

Further, if the same application program that is already started is present (YES in block B1), the application control module 101 checks whether data recorded for the application program is present or not (block B6). If data recorded for the application program is not present (NO in block B6), the application control module 101 arranges a window of an application program to be newly started near the coordinates of the window of another application program that is already started (block B7). When a plurality of same application programs are already started, for example, the window is arranged near the window for the application program that is started at the latest time among the same application programs.

If the record data for the application program is present (YES in block B6), the application control module 101 reads and analyzes the record data (block B8). Further, the application control module 101 checks whether or not an application program whose window is arranged in a position indicated by the record data is present among the other application programs already started (block B9). If the application program is not present (NO in block B9), the application control module 101 arranges the window for the above application program with the newest coordinates and size among the record data (block B10). If another application program whose window is arranged in a position indicated by the record data is present (YES in block B9), the application control module 101 arranges the window for the application program with the newest coordinates and size in the record data and among the coordinates obtained by excluding the coordinates in which the windows of the other application programs that are already started are already arranged (block B11).

More simply, it is possible to utilize a procedure of arranging a window in the position recorded at the latest time if the first application program is started and arranging a window in the second newly recorded position if the second application program is started (irrespective of the arrangement state of the windows of the same application programs that are already started) for each application program.

As described above, the computer 1 of this embodiment properly arranges the display regions at the start time of a plurality of same application programs.

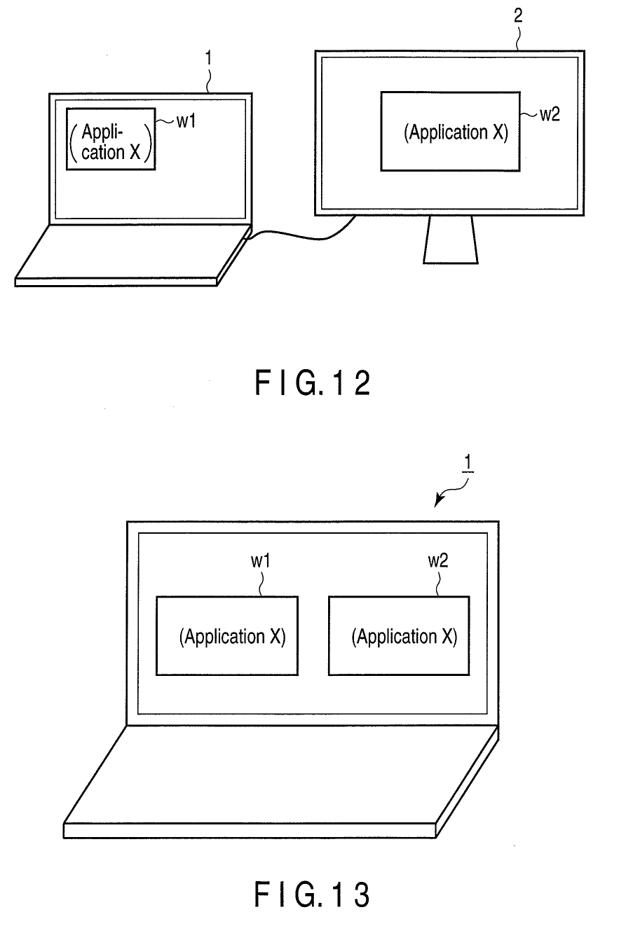

In the above description, an example in which a plurality of windows are arranged in proper positions when a plurality of same application programs are started by recording a plurality of arrangements of the windows for each application program in the computer 1 including two display devices (LCD 16a, 16b) mounted thereon is explained. However, a device for performing the arrangement control for the plural windows of the same application programs is not limited to the computer 1 including the two display devices mounted thereon. For example, as shown in FIG. 12, even in a computer 1 including only one display device mounted thereon, the arrangement control method for the plural windows of the same application programs as described before (by recording plural arrangements of the windows of the respective application programs) is useful when an external display device 2 is connected thereto and two display devices are used as a multi-monitor. Further, as shown in FIG. 13, even in a single body of a computer 1 including only one display device mounted thereon, it is sufficiently considered to use a utilization method of starting a plurality of same application programs and displaying the windows thereof side by side. Therefore, the arrangement control method for the plural windows of the same application programs as described before (by recording plural arrangements of the windows of the respective application programs) is useful.

In the above case, as information indicating a region in which the window of each application program is arranged on the display screen (application utilization information 102), an example of recording the coordinates and size of the window is explained. The same state as that of the preceding case can be realized by recording only the coordinates of the coordinates and size and arranging a window of a preset size with the recorded coordinates as an origin.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a central processing unit (CPU);
a display;
a recording module configured to record one or more position information items, each indicating a position on a screen of the display associated with a display region of an instance of an application program executed by the CPU, wherein an amount of the one or more position information items recorded is associated with an amount of simultaneously executed instances of the application program; and
an arrangement module configured to arrange display regions on the screen based on the one or more position information items when the instances of the application program associated with the one or more position information items are activated.

2. The apparatus of claim 1, wherein the arrangement module is further configured to arrange a display region of a newly activated instance of the application program in a position associated with the latest recorded position information item not associated with an already activated instance of the application program.

3. The apparatus of claim 1, wherein the arrangement module is further configured to arrange a display region of a first instance of the application program based on the latest recorded position information item when the first instance of the application program is activated, and to arrange a display region of a second instance of the application program based on the second latest recorded position information item when the second instance of the application program is activated.

4. The apparatus of claim 1, wherein the one or more position information items comprise coordinates on the screen associated with one corner of the display region.

5. The apparatus of claim 4, wherein the one or more position information items further comprise a size of the display region.

6. The apparatus of claim 1, wherein the recording module is further configured to acquire and record the one or more position information items when the instances of the application program are terminated.

7. A display region arrangement method of an information processing apparatus, the method comprising:
recording one or more position information items, each indicating a position on a screen of a display associated with a display region of an instance of an application program, wherein an amount of the one or more position information items recorded is associated with an amount of simultaneously executed instance of the application program; and
arranging display regions on the screen based on the one or more position information items when the instances of the application program associated with the one or more position information items are activated.

8. The method of claim 7, wherein arranging the display regions further comprises arranging a display region of a newly activated instance of the application program in a position associated with the latest recorded position information item not associated with an already activated instance of the application program.

9. The method of claim 7, wherein arranging the display regions further comprises arranging a display region of a first instance of the application program based on the latest recorded position information item when the first instance of the application program is activated, and arranging a display region of a second instance of the application program based on the second latest recorded position information item when the second instance of the application program is activated.

10. The method of claim 7, wherein the one or more position information items comprise coordinates on the screen associated with one corner of the display region.

11. The method of claim 10, wherein the one or more position information items further comprise a size of the display region.

12. The method of claim 7, wherein recording the one or more position information items further comprises acquiring and recoding the one or more position information items when the instances of the application program are terminated.
